(19) United States
(12) Patent Application Publication
(10) Pub. No.: US 2014/0022634 A1
(43) Pub. Date: Jan. 23, 2014

(54) 3D DISPLAY AND ALIGNMENT METHOD THEREOF

(71) Applicant: Satoru Takahashi, Chu-Nan (TW)

(72) Inventor: Satoru Takahashi, Chu-Nan (TW)

(73) Assignees: CHIMEI INNOLUX CORPORATION, Chu-Nan (TW); INNOCOM TECHNOLOGY (SHENZHEN) CO., LTD., Shenzhen City (CN)

(21) Appl. No.: 13/551,506

(22) Filed: Jul. 17, 2012

(51) Int. Cl. G02B 27/22

(52) U.S. Cl. 359/463

(57) ABSTRACT

A 3D display, at least comprising a display panel, a backlight module disposed beneath the display panel and a lens sheet disposed on the display panel is provided. The display panel comprises a display medium sandwiched between two substrates, and at least two alignment marks are formed at one of the substrates, and each alignment mark comprises an indicator and a reference mark. The lens sheet has an array of plural lenticular elements arranged in a lens direction, wherein the alignment marks are identifiable through the lens sheet and corresponding alignment mark images are presented on the lens sheet, and each alignment mark image comprises an indicator image and a reference mark image. Whether the alignment between the lens sheet and the display panel is accurate is determined by a correlation between the indicator image and the reference mark image.

### BACKGROUND

1. Technical Field

The disclosed embodiments relate in general to a 3D display and an alignment method thereof, and more particularly to a lenticular-type 3D display and an alignment method thereof, for accurately aligning a lens sheet and a display panel of the 3D display.

2. Description of the Related Art

Autostereoscopic displays, also known as “Naked eye 3D display”, are able to provide binocular depth perception without the hindrance of specialized headgear or filter/shutter glasses. The naked eye 3D display technology has been developed for many years to provide stereoscopic vision by fooling the human brain, so that a 2D medium can display a 3D image by providing a stereo parallax view for the user. Naked eye 3D displays have been demonstrated using a range of optical elements in combination with an LCD including parallax barrier technology and lenticular optic technology to provide stereoscopic vision. In a barrier-type 3D display, the parallax barrier has optical apertures is aligned with columns of LCD pixels, which could be a sheet with a particular fine trip pattern, or an electro optic panel with fine and vertical stripes (i.e. a display panel), alternatively. In a lenticular -type 3D display, a lens sheet having lenticular optics such as hemicylindrical lenses is aligned with columns of LCD pixels.

FIG. 1 is a top view of a lenticular-type 3D display with a lens sheet in front of display panel. FIG. 2 is a cross-sectional view of the lenticular-type 3D display along the cross-sectional line AA′ of FIG. 1. Please refer to FIG. 1 and FIG. 2. The lenticular-type 3D display 1 includes a backlight system 11, a display panel 13 on the backlight system 11, a lens sheet 15 attached on the display panel 13 by an adhesive 17 (such as glue). The display panel 13 includes a top substrate 132, a bottom substrate 134, and two polarizers 136a and 136b respectively at two sides of the top substrate 132 and the bottom substrate 134. One example of the display panel 13 is liquid crystal display (LCD). The lenticular elements of the lens sheet 15 are typically hemicylindrical lenses 153 arranged vertically with respect to the display panel 13. Generally, high accurate alignment between the display panel 13 and the lens sheet 15 is required in the x positions (i.e. the positions to x-direction (lens direction)) for high quality 3D performance, but not required in the y positions.

FIG. 3 is an enlarging view illustrating part of the lenticular-type 3D display of FIG. 2, to reveal the front lenticular autostereoscopic display principle. The hemcylindrical lenses 153 direct the diffuse light from a pixel so it can only be seen in a limited angle in front of the 3D display 1. This then allows different pixels to be directed to either the left or right viewing windows. As shown in FIG. 3, which illustrating the principle for a two view lenticular element stereoscopic display, the lens sheet 15 needs to be accurately set to ensure pixels at the edge of the display are seen correctly in the left and right viewing windows. The left eye pixels (such as pixels 137L) present images for left eye, and the right eye pixels (such as pixels 137R) present images for right eye. The hemcylindrical lenses 153 separate the light pathway of spatial images into images for left eye and right eye to perceive 3D images. A lens pitch/can be found by:

$$l = 2 i ( \frac{z - f}{z} ) ,$$

where i is a pixel pitch, e is an eye separation and window width, f is a focal length, and z is a distance to viewing windows.

FIG. 4A is a top view of a conventional lenticular-type 3D display. FIG. 4B is an enlarging view illustrating part of a lens sheet in front of a display panel of FIG. 4A. As shown in FIG. 4A and FIG. 4B, the lens sheet 15 having plural hemicylindrical lenses 153 is attached on the display panel 13′, and an alignment mark 13A on the display panel 13′ is positioned outside of the lens sheet 15. The alignment mark 13A and the valley of the hemicylindrical lenses 153 are detected for adjusting the lens sheet 15 to a setup position.

### SUMMARY

The disclosure is directed to lenticular-type 3D displays and alignment methods thereof, and the alignment marks and alignment method of the present embodiments are provided for accurately aligning a lens sheet with a display panel of the 3D display.

According to one embodiment, a three-dimensional (3D) display is provided, at least comprising a display panel, a backlight module disposed beneath the display panel and a lens sheet disposed on the display panel. The display panel comprises a display medium sandwiched between two substrates, and at least two alignment marks are formed at one of the substrates, and each alignment mark comprises an indicator and a reference mark. The lens sheet has an array of plural lenticular elements (such as hemicylindrical lenses) arranged in a lens direction, wherein the alignment marks are identifiable through the lens sheet and corresponding alignment mark images are presented on the lens sheet, and each alignment mark image comprises an indicator image and a reference mark image. Whether the alignment between the lens sheet and the display panel is accurate is determined by a correlation between the indicator image and the reference mark image.

According to one embodiment, an alignment method applied to a lenticular-type 3D display is provided, comprising:

providing a display panel with at least two alignment marks and a lens sheet disposed on the display panel, and each alignment mark comprising an indicator and a reference mark, and the lens sheet having an array of plural lenticular elements arranged in a lens direction;

capturing identifiable alignment mark images presented on top of the lens sheet by an image capture tool, and the alignment mark images generated by the corresponding alignment marks through the lens sheet, wherein each alignment mark image comprises an indicator image and a reference mark image;

analyzing the alignment mark images by an alignment shift analysis software to determine whether an alignment between the lens sheet and the display panel is accurate according to a correlation of positions or sizes of the indicator image and the reference mark image, wherein the alignment shift analysis software is coupled to the image capture tool;

calculating and obtaining a position shift result for each of the alignment marks by the alignment shift analysis software; and

adjusting a corresponding position between the display panel and the lens sheet according to the position shift results of the alignment marks.

### BRIEF DESCRIPTION OF THE DRAWINGS

FIG. 1 is a top view of a lenticular-type 3D display with a lens sheet in front of display panel.

FIG. 2 is a cross-sectional view of the lenticular-type 3D display along the cross-sectional line AA′ of FIG. 1. Please refer to FIG. 1 and FIG. 2.

FIG. 3 is an enlarging view illustrating part of the lenticular-type 3D display of FIG. 2, to reveal the front lenticular autostereoscopic display principle.

FIG. 4A (prior art) is a top view of a conventional lenticular-type 3D display.

FIG. 4B (prior art) is an enlarging view illustrating part of a lens sheet in front of a display panel of FIG. 4A.

FIG. 5 schematically illustrates an alignment mark on the display panel and an image of the alignment mark presented on the top of the lens sheet, at accurate alignment between the lens sheet and the display panel, according to the first embodiment of the disclosure.

FIG. 6A schematically illustrates the alignment mark on the display panel according to the first embodiment and an image of the alignment mark (36I′) presented on the top of the lens sheet at a lens shift-to-right condition.

FIG. 6B schematically illustrates the alignment mark on the display panel according to the first embodiment and an image of the alignment mark (36I″) presented on the top of the lens sheet at a lens shift-to-left condition.

FIG. 7A schematically illustrates an alignment mark of the first embodiment shown on the display panel and an image of the alignment mark presented on the top of the lens sheet at a lens shift-to-right condition.

FIG. 7B is a simple drawing showing the related factors of the alignment mark and presented image of the alignment mark of FIG. 7A.

FIG. 8 illustrates one of applicable 3D alignment devices according to one of the embodiment of the present disclosure.

FIG. 9 is a flow chart of a 3D alignment method for display panel and lens sheet according to the embodiments of the disclosure.

FIG. 10 depicts corresponding drawings for illustrating relative steps of FIG. 9 according to the first embodiment.

FIG. 11 schematically illustrates an alignment mark on the display panel and an image of the alignment mark presented on the top of the lens sheet, at accurate alignment between the lens sheet and the display panel, according to the second embodiment of the disclosure.

FIG. 12A schematically illustrates the alignment mark on the display panel according to the second embodiment and an image of the alignment mark (66I′) presented on the top of the lens sheet at a lens shift-to-right condition.

FIG. 12B schematically illustrates the alignment mark on the display panel according to the second embodiment and an image of the alignment mark (66I″) presented on the top of the lens sheet at a lens shift-to-left condition.

FIG. 13 schematically illustrates an alignment mark of the second embodiment shown on the display panel and an image of the alignment mark presented on the top of the lens sheet at a lens shift-to-right condition.

FIG. 14 depicts corresponding drawings for illustrating relative steps of FIG. 9 according to the second embodiment.

FIG. 15 schematically illustrates a lens sheet and an alignment mark on the display panel according to the third embodiment of the disclosure.

FIG. 16 schematically illustrates a lens sheet and an alignment mark on the display panel according to the fourth embodiment of the disclosure.

FIG. 17 schematically illustrates a lens sheet and an alignment mark on the display panel according to the fifth embodiment of the disclosure.

FIG. 18 schematically illustrates a lens sheet and an alignment mark on the display panel according to the sixth embodiment of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Embodiments of 3D displays and alignment methods thereof, particularly to the lenticular-type 3D displays and alignment methods thereof, are provided to demonstrate the configurations of alignment marks and alignment method of the present disclosure, in order to accurately align a lens sheet with a display panel of the 3D display.

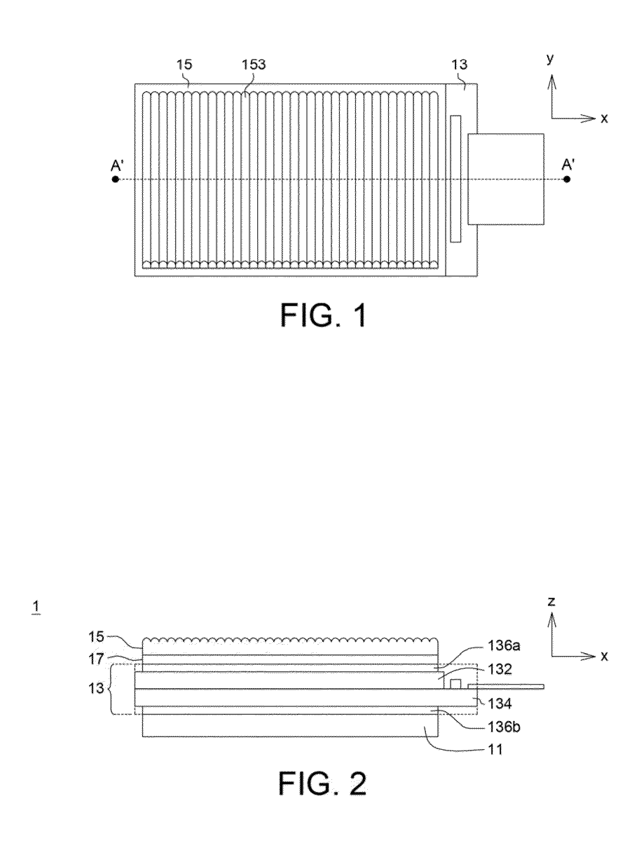

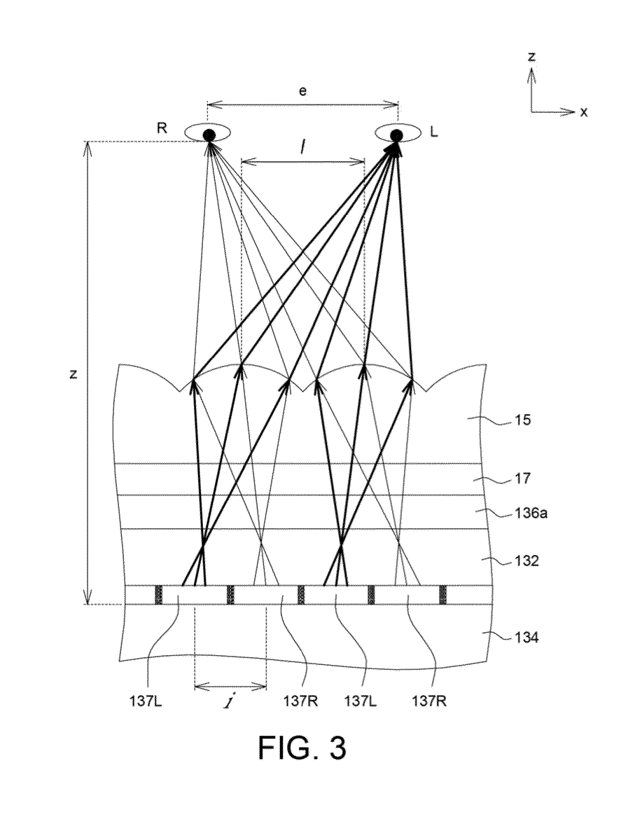

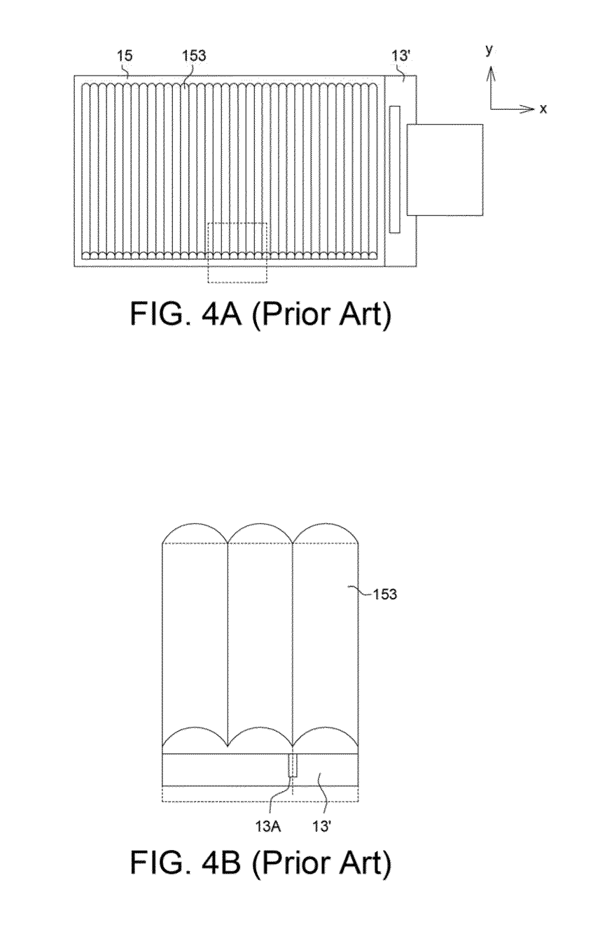

The disclosed embodiments provide several configurations of alignment marks and descriptions of the corresponding alignment methods. However, the invention is not limited thereto, and the modifications and variations can be made without departing from the spirit of the disclosure to meet the requirements of the practical applications. Also, a lenticular-type 3D display of the embodiment, basically including a backlight module disposed beneath a display panel, and a lens sheet attached on the display panel, and the lens sheet having several lenticular elements such as hemicylindrical lenses arranged in a lens direction, could be referred to FIG. 1 and FIG. 2 and is not redundantly illustrated herein. The disclosure is also applicable to other types of lenticular 3D displays. One example of the display panel of the embodiment is a LCD, comprising a display medium sandwiched between two substrates.

The display panel of the lenticular-type 3D display of the embodiment includes at least one alignment mark, which are formed at one of the substrates of the display panel. In the embodiments, the alignment marks are identifiable through the lens sheet and the corresponding alignment mark images are presented on top of the lens sheet, and each alignment mark image comprises an indicator image and a reference mark image. Whether the alignment between the lens sheet and the display panel is accurate is determined by a correlation between the indicator image and the reference mark image according to the embodiments; for example, determined according to positions or sizes of the indicator image and the reference mark image.

### First Embodiment

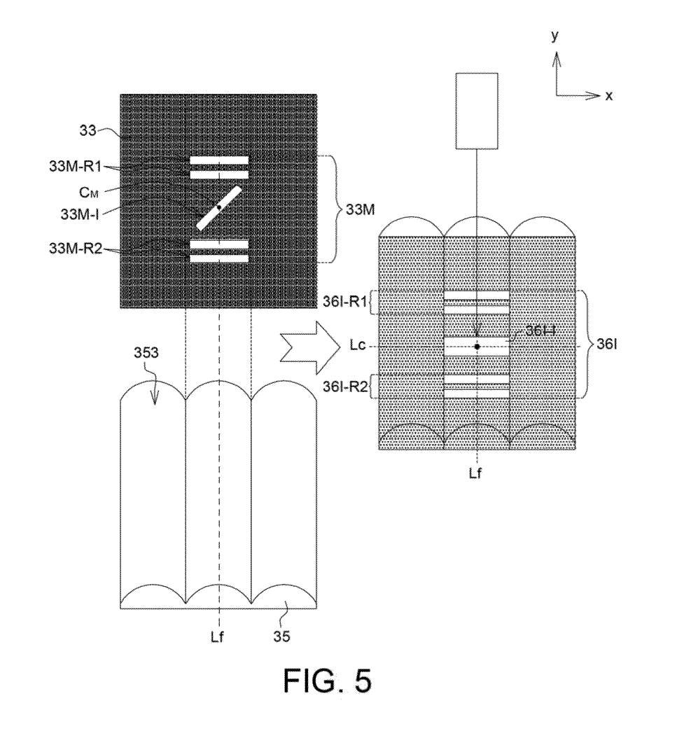

FIG. 5 schematically illustrates an alignment mark on the display panel and an image of the alignment mark presented on the top of the lens sheet, at accurate alignment between the lens sheet and the display panel, according to the first embodiment of the disclosure.

In the first embodiment, each alignment mark 33M on the display panel 33 comprises an indicator 33M-I and a reference mark. The reference mark could be two groups of reference lines, and the indicator 33M-I is positioned between the two groups of reference lines, wherein each group of reference lines may include one or more of reference lines. As shown in FIG. 5, the reference mark of the first embodiment includes a first group of reference lines 33M-R1 and a second group of reference lines 33M-R2 respectively positioned at the upper and lower sides of the indicator 33M-I, wherein each group has two reference lines parallel to the lens direction (i.e. x-direction). The indicator 33M-I of the first embodiment is a slanted line from the lens direction, which means the direction of the indicator 33M-I is inclined to the lens array. Also, in the first embodiment, a center C_{M} of the indicator 33M-I on the display panel 33 is corresponding to half a distance between the first group of reference lines 33M-R1 and the second group of reference lines 33M-R2.

Furthermore, each alignment mark 33M of the first embodiment is positioned correspondingly to one hemicylindrical lens 353 of the lens sheet 35. After staking the lens sheet 35 on the alignment mark 33M, the alignment mark 33M on the display panel 33 is identifiable through the lens sheet 35 and present a corresponding alignment mark image 36I (36I′/36I″) on top of the lens sheet 35. The alignment mark image 36I could be captured by an image capturing tool such as CCD, for the subsequent image analyses. Each alignment mark image 36I comprises an indicator image 36I-I and the reference mark images such as the first group of reference line image 36I-R1 and the second group of reference line image 36I-R2. In the first embodiment, shapes and sizes of the first group of reference line image 36I-R1 and the second group of reference line image 36I-R2 presented on the lens sheet 35 are identical to the that of the first group of reference lines 33M-R1 and the second group of reference lines 33M-R2 configured on the display panel 33, since no deformation occurs on the reference lines parallel to x-direction. The indicator image 36I-I corresponding to the slanted indicator 33M-I is deformed by the hemicylindrical lens 353 and presents a stripe pattern parallel to x-direction, as shown in FIG. 5.

Center line L_{C} of the indicator image 36I-I indicates the shift condition of the lens sheet 35. Also, the shift value of the lens sheet 35 can be estimated and calculated according to a correlation of positions of the indicator image 36I-I and the reference mark images (e.g. the first group of reference line image 36I-R1 and the second group of reference line image 36I-R2) by alignment shift analysis software.

As shown in FIG. 5, If the lens sheet 35 and the display panel 33 are accurately aligned at a correct position, which means a focusing line L_{f} of the hemicylindrical lens 353 is aligned with the center C_{M} of the indicator, the center line L_{C} of the indicator image 36I-I is substantially at a middle position (e.g. half a distance) between the first group of reference line image 36I-R1 and the second group of reference line image 36I-R2.

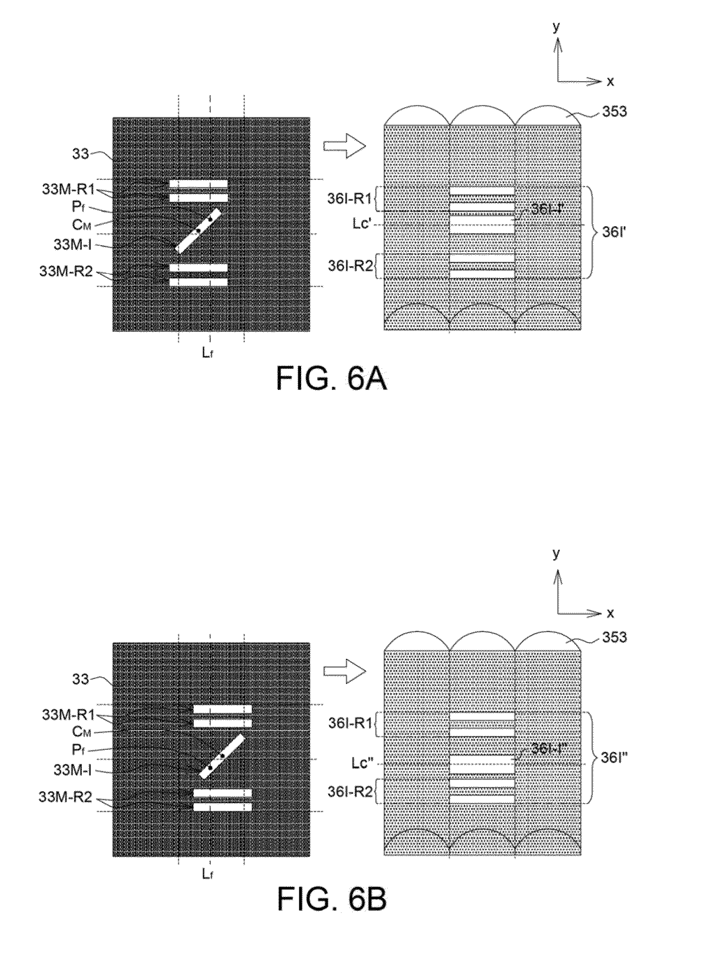

FIG. 6A schematically illustrates the alignment mark on the display panel according to the first embodiment and an image of the alignment mark (36I′) presented on the top of the lens sheet at a lens shift-to-right condition. If the lens sheet 35 is shifted to the right side of the display panel 33 during pre-alignment, which means the focusing line L_{f} of the hemicylindrical lens 353 is positioned relatively to the right side of the indicator 33M-I and a lens focusing point P_{f} on the mark of the indicator 33M-I is shifted to an upward-direction, the center line L_{C}′ of the indicator image 36I-I′ moves upwardly and be close to the first group of reference line image 36I-R1.

FIG. 6B schematically illustrates the alignment mark on the display panel according to the first embodiment and an image of the alignment mark (36I″) presented on the top of the lens sheet at a lens shift-to-left condition. If the lens sheet 35 is shifted to the left side of the display panel 33 during pre-alignment, which means the focusing line L_{f} of the hemicylindrical lens 353 is positioned relatively to the left side of the indicator 33M-I and a lens focusing point P_{f} on the mark of the indicator 33M-I is shifted to a downward-direction, the center line L_{C}″ of the indicator image 36I-I″ moves downwardly and be close to the second group of reference line image 36I-R2.

Accordingly to the descriptions of FIG. 6A and FIG. 6B, the center line (L_{C}′/L_{C}″) of the indicator image (36I-I′/36I-I″) shifts along the y direction if the lens sheet 35 shifts to the alignment mark 33M along the x position.

### Calculation of Lens Position Shift of the First Embodiment

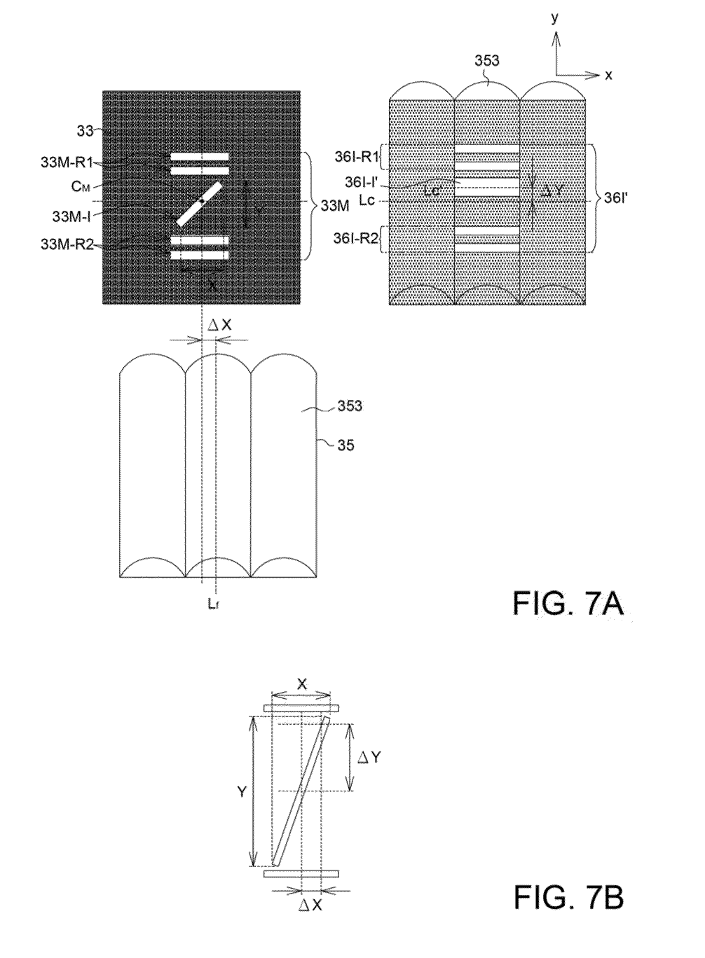

FIG. 7A schematically illustrates an alignment mark of the first embodiment shown on the display panel and an image of the alignment mark presented on the top of the lens sheet at a lens shift-to-right condition. The related factors of calculation are also indicated in FIG. 7A. Configurations and correlations between the alignment mark 33M on the display panel 33 and the corresponding alignment mark image 36I′ presented on top of the lens sheet 35 in FIG. 7A are similar to that of FIG. 6A, and not repeatedly described. FIG. 7B is a simple drawing showing the related factors of the alignment mark and presented image of the alignment mark of FIG. 7A. As shown in FIG. 7A and FIG. 7B, the factors involved in the calculation includes: dimensional factor X of the alignment mark 33M: a horizontal width of the indicator 33M-I;

dimensional factor Y of the alignment mark 33M: a vertical width of the indicator 33M-I;

ΔY: an image shift value along y-direction, by determining shift between a center line L_{C}′ of the indicator image 36I-I′ and an ideal center line L_{C} (i.e. a center line of an indicator image 36I-I presented while the lens sheet is accurately aligned with the display panel, as shown in FIG. 5); and

ΔX: a x-position shift value of the lens sheet 35 along x-direction.

Dimensional factors X and Y of the alignment mark 33M are known values which can be inputted into an alignment shift analysis software before capturing the alignment mark images. ΔY could be obtained by averaging brightness of the alignment mark image 36I′, followed by comparing an indicator image averaged brightness and a reference mark image averaged brightness. ΔX can be calculated by the formula (1):

$$Δ X = \frac{X}{Y} \cdot Δ Y . \qquad ( 1 )$$

Applicable Alignment 3D Device and Algorithm of Alignment between Lens Sheet and Display Panel

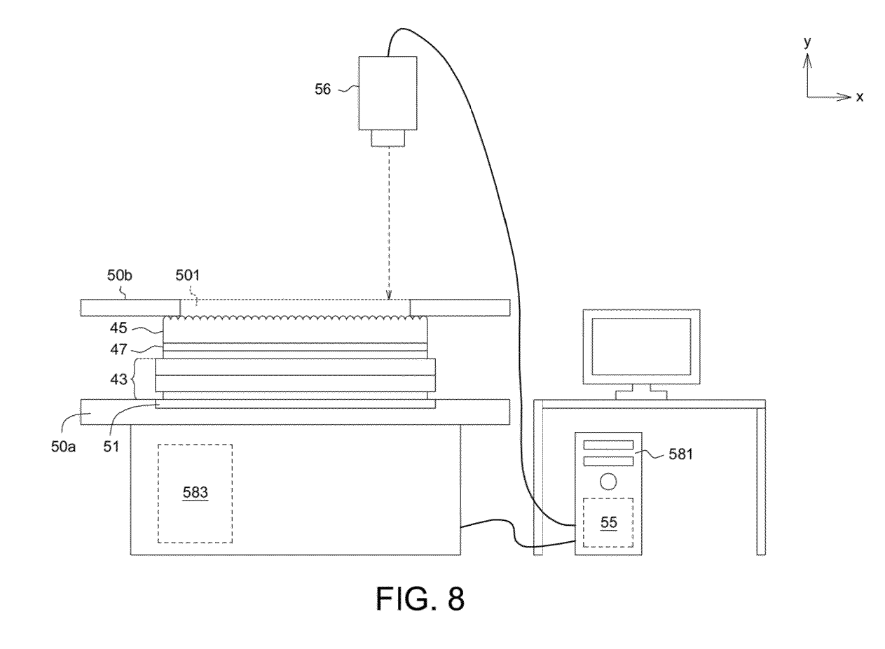

FIG. 8 illustrates one of applicable 3D alignment devices according to one of the embodiment of the present disclosure. In one applicable 3D alignment device 5, as shown in FIG. 8, a lens sheet 45 loaded on a 3D component stage 50b is stacked on a display panel 43 (ex: LCD panel) loaded on a display x-y stage 50a (with a backlight 51 thereon), and an UV glue 47 is dispersed between the lens sheet 45 and the display panel 43. The 3D alignment device 5 might comprise an image capture tool 56 disposed above the 3D component stage 50b and an alignment shift analysis software 55 coupled to the image capture tool 56. The image capture tool 56, such as a CCD or a camera, captures an identifiable alignment mark images presented on top of the lens sheet 45, wherein the alignment mark images (comprising an indicator image and a reference mark image) are generated by the corresponding alignment marks on the display panel 43 through the lens sheet 45. The alignment shift analysis software 55 coupled to the image capture tool 56 is executed by a processor comprising logic to analyze the alignment mark images and determine whether an alignment between the lens sheet 45 and the display panel 43 is accurate. The distance between the image capture tool 56 and the lens sheet 45 is deviated from an optimum 3D viewing distance. A position shift result (such as Δx) for each of the alignment marks of the embodiment could be calculated and obtained by the alignment shift analysis software 55. Also, a rotation angle (at a x-y plane) between the display panel 43 and the lens sheet 45 could be calculated and obtained by the alignment shift analysis software 55 according to the position shift results of the alignment marks. Then, a relative position between the display panel 43 and the lens sheet 45 can be adjusted according to the position shift results of the alignment marks of the embodiment, by moving the 3D component stage 50b or the display x-y stage 50a.

Optionally, the 3D alignment device 5 further includes a main control unit 581 (such as a processor/computer comprising logic) and a stage control unit 583 coupled to the alignment shift analysis software 55 and at least one of the 3D component stage 50b and the display x-y stage 50a. The stage control unit 583 is used for adjusting corresponding position between the display panel 43 and the lens sheet 45 according to the position shift results of the alignment marks and the rotation angle (ex: if the position shift results of the alignment marks and the rotation angle exceed predetermined alignment errors).

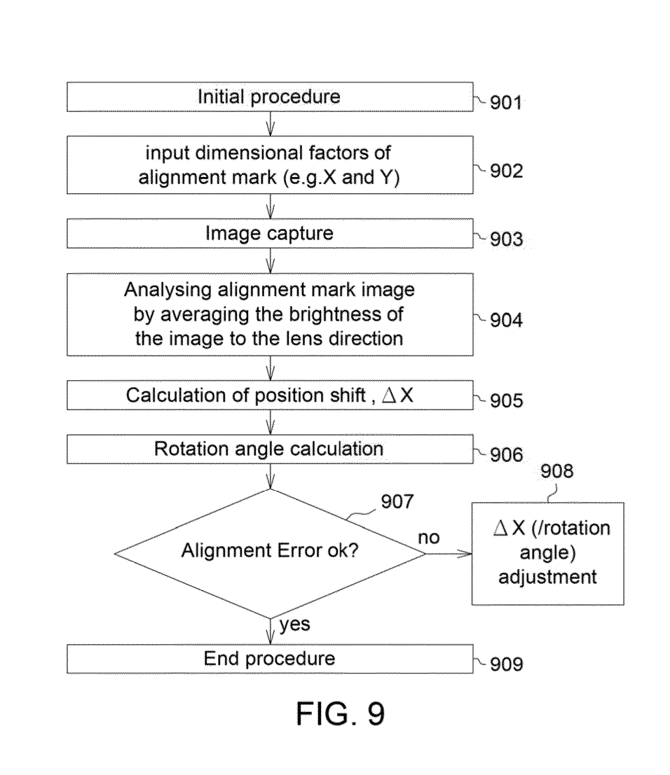

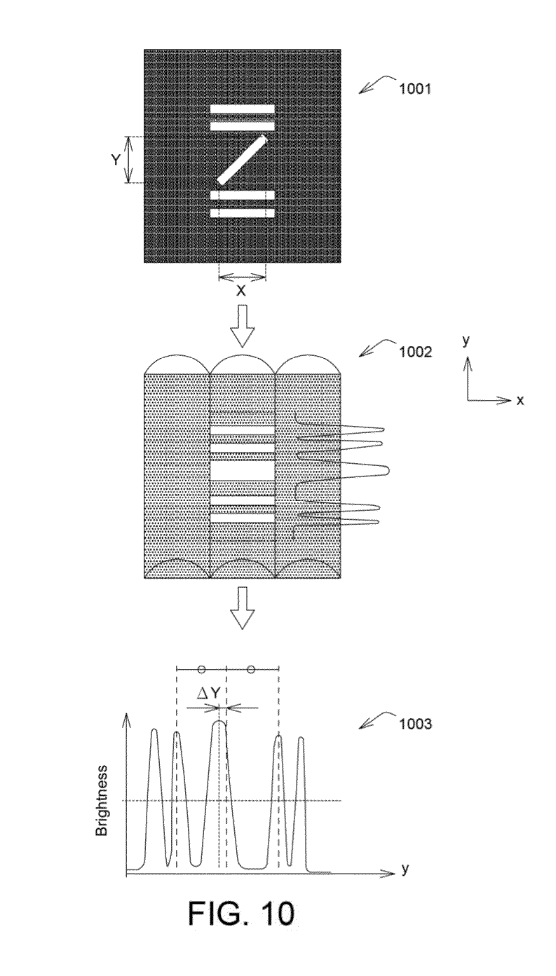

FIG. 9 is a flow chart of a 3D alignment method for display panel and lens sheet according to the embodiments of the disclosure. Please also refer to FIG. 10, which depicts the corresponding drawings for illustrating relative steps of FIG. 9 according to the first embodiment.

In step 901, an initial procedure is performed, such as loading the display panel (such as LCD) with special alignment marks thereon and the lens sheet on the stages as shown in FIG. 8, and conducting the pre-alignment. In the first embodiment, the display panel 43 with at least two alignment marks is provided, and each alignment mark comprising an indicator and a reference mark, as shown in the pattern 1001 of FIG. 10.

In step 902, the dimensional factors of each alignment mark, such as X and Y of pattern 1001 of FIG. 10, are inputted to an alignment shift analysis software 55.

In step 903, an image capture procedure is performed (such as by an image capture tool 56) to capture an identifiable alignment mark images presented on top of the lens sheet 45, wherein the alignment mark images is generated by the corresponding alignment marks on the display panel 43 through the lens sheet 45 having an array of plural lenticular elements arranged in a lens direction. In the first embodiment, each alignment mark image comprises an indicator image and a reference mark image, as shown in the pattern 1002 of FIG. 10. The details of the alignment mark and corresponding alignment mark image of the first embodiment have been discussed in the aforementioned description and not redundantly repeated here.

In step 904, the alignment mark images are analyzed by the alignment shift analysis software 55 to determine whether an alignment between the lens sheet 45 and the display panel 43 is accurate. In the first embodiment, step of analyzing the alignment mark images comprises averaging brightness of the alignment mark images to the lens direction (i.e. x-direction), including an indicator image averaged brightness and a reference mark image averaged brightness of each reference mark image to the lens direction, as illustrated in the pattern 1003 of FIG. 10. Whether an alignment between the lens sheet 45 and the display panel 43 is accurate is determined by a correlation of positions of the indicator image and the reference mark image.

In step 905, calculation of the position shift result for each of the alignment marks by the alignment shift analysis software is performed, and an image shift value along y-direction, ΔY, by comparing the indicator image averaged brightness and the reference mark image averaged brightness, is obtained. In the first embodiment, a x-position shift value along x-direction, ΔX, can be calculated according to the formula (1) as presented above.

As shown in step 906, the alignment method may optionally include calculation of rotation angle (by the alignment shift analysis software 55) between the display panel 43 and the lens sheet 45, according to the position shift results of the alignment marks.

In step 907, whether the alignment between the display panel 43 and the lens sheet 45 is accurate is determined; for example, by checking the calculation results (such as Δx and rotation angle) with predetermined alignment error. The predetermined alignment errors are previously inputted to the alignment shift analysis software 55. If the calculation results exceed the predetermined alignment errors, a corresponding position (and rotation angle) between the display panel 43 and the lens sheet 45 is adjusted according to the position shift results of the alignment marks, as indicated in step 908. If the alignment shift analysis software 55 judges the calculation results being within the predetermined alignment errors, the end procedure of alignment is executed, as indicated in step 909. It is noted that those steps disclosed above are not the limitation of the disclosure, and the details could be modified, depending on the requirements of practical applications.

### Second Embodiment

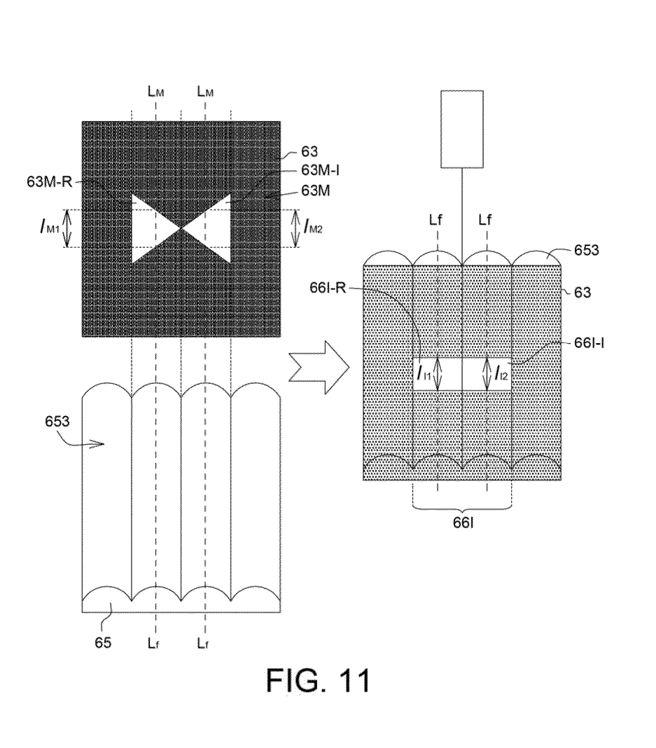

FIG. 11 schematically illustrates an alignment mark on the display panel and an image of the alignment mark presented on the top of the lens sheet, at accurate alignment between the lens sheet and the display panel, according to the second embodiment of the disclosure.

In the second embodiment, each alignment mark 63M on the display panel 63 comprises an indicator 63M-I and a reference mark 63M-R. The reference mark and the indicator could be mirror patterns positioned correspondingly to one or two of the lenticular elements. As shown in FIG. 11, the indicator 63M-I and the reference mark 63M-R are two triangles with mirror symmetry, and respectively positioned correspondingly to two hemicylindrical lenses 653 (lenticular elements) of the lens sheet 65. Also, the triangle points of the indicator 63M-I and the reference mark 63M-R are positioned correspondingly to valleys of the hemicylindrical lenses 653, and the heights (width) of the triangle indicator 63M-I and the reference mark 63M-R are substantially the same as the lens pitch.

After staking the lens sheet 65 on the alignment mark 63M, the alignment mark 63M on the display panel 63 is identifiable through the lens sheet 65 and present a corresponding alignment mark image 66I (66I′/66I″) on top of the lens sheet 65. The alignment mark image 66I could be captured by an image capturing tool such as CCD, for the subsequent image analyses. Each alignment mark image 66I comprises an indicator image 66I-I and the reference mark image 66I-R. In the second embodiment, indicator image 66I-I and the reference mark image 66I-R respectively corresponding to the indicator 63M-I and the reference mark 63M-R are deformed by the hemicylindrical lens 653, and present as two rectangular shapes, as shown in FIG. 11.

In the second embodiment, configurations of the indicator image and the reference mark image indicate the shift condition of the lens sheet 65.

As shown in FIG. 11, if the lens sheet 65 and the display panel 63 are accurately aligned at a correct position, which means the focusing lines L_{f} of the hemicylindrical lens 653 are aligned with the middle lines L_{M} of indicator 63M-I and the reference mark 63M-R, the indicator image 66I-I and the reference mark image 66I-R present substantially identical sizes (shapes). FIG. 11 illustrates the focusing length l_{M1} of the reference mark 63M-R and the focusing length l_{M2} of the indicator 63M-I are the same, the projected width l_{I2} of the indicator image 66I-I and the projected width l_{I1} of the reference mark image 66I-R would be the same, thereby resulting identical sizes and shapes of the indicator image 66I-I and the reference mark image 66I-R.

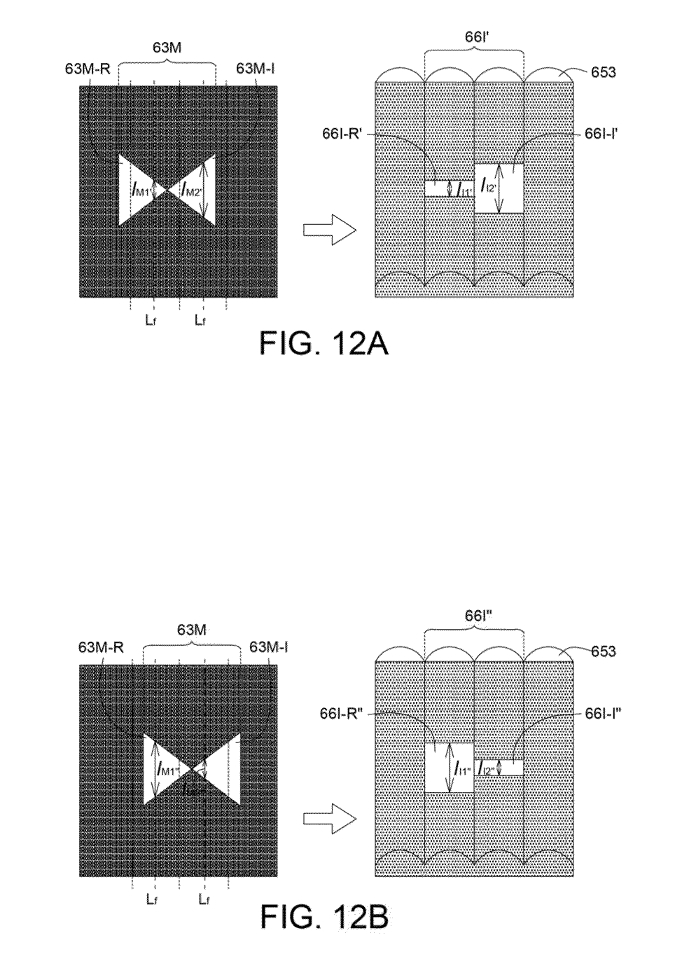

FIG. 12A schematically illustrates the alignment mark on the display panel according to the second embodiment and an image of the alignment mark (66I′) presented on the top of the lens sheet at a lens shift-to-right condition. If the lens sheet 65 is shifted to the right side of the display panel 63 during pre-alignment, which means the focusing line L_{f} of the hemicylindrical lens 653 is positioned relatively to the right side of the indicator 63M-I and the reference mark 63M-R, the focusing length l_{M1}′ of the reference mark 63M-R is shorter than the focusing length l_{M2}′ of the indicator 63M-I, resulting in a larger detected image presented in the right side. As shown in FIG. 12A, the projected width l_{I2}′ of the indicator image 66I-I′ is larger than the projected width l_{I1}′ of the reference mark image 66I-R′, and consequently, the size of the indicator image 66I-I′ is larger than the size of the reference mark image 66I-R′.

FIG. 12B schematically illustrates the alignment mark on the display panel according to the second embodiment and an image of the alignment mark (66I″) presented on the top of the lens sheet at a lens shift-to-left condition. If the lens sheet 65 is shifted to the left side of the display panel 63 during pre-alignment, which means the focusing line L_{f} of the hemicylindrical lens 653 is positioned relatively to the left side of the indicator 63M-I and the reference mark 63M-R, the focusing length l_{M1}″ of the reference mark 63M-R is longer than the focusing length l_{M2}″ of the indicator 63M-I, resulting in a larger detected image presented in the left side. As shown in FIG. 12B, the projected width l_{I1}″ of the reference mark image 66I-R″ is larger than the projected width l_{I2}″ of the indicator image 66I-I″, and consequently, the size of the indicator image 66I-I″ is larger than the size of the reference mark image 66I-R″.

According to the descriptions of FIG. 12A and FIG. 12B, differences of the widths (eg. l_{I1}′ vs. l_{I2}′ or l_{I1}″ vs. l_{I2}″) between the indicator image (66I-I′ or 66I-I″) and the reference mark image (66I-R′ or 66I-R″) indicates x position shift.

### Calculation of Lens Position Shift of the Second Embodiment

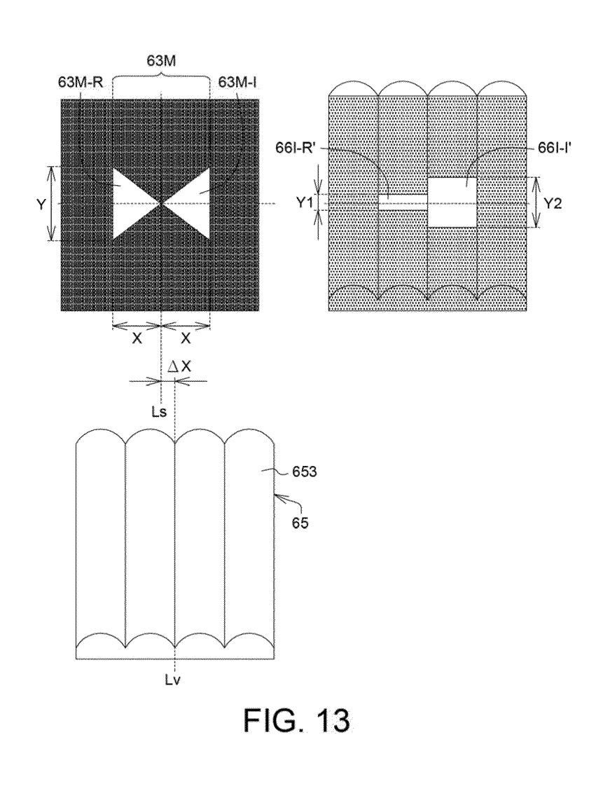

FIG. 13 schematically illustrates an alignment mark of the second embodiment shown on the display panel and an image of the alignment mark presented on the top of the lens sheet at a lens shift-to-right condition. The related factors for calculation are also indicated in FIG. 13. Configurations and correlations between the alignment mark 63M on the display panel 63 and the corresponding alignment mark image 66I′ presented on top of the lens sheet 65 of FIG. 13 are similar to that of FIG. 12A, and not repeatedly described. FIG. 13 is a simple drawing showing the related factors of the alignment mark and presented image of the alignment mark of FIG. 12A. As shown in 13, the factors involved in the calculation includes:

dimensional factor X of the alignment mark 63M: a height (parallel to x-direction) of one of the indicator 63M-I and the reference mark 63M-R, which are two mirror-symmetric triangles;

dimensional factor Y of the alignment mark 63M: a bottom length (parallel to y-direction) of one of the indicator 63M-I and the reference mark 63M-R;

Y1: the projected width (e.g. l_{I1}′ of FIG. 12A) of the reference mark image 66I-R′;

Y2: the projected width (e.g. l_{I2}′of FIG. 12A) of the indicator image 66I-I′; and

ΔX: a x-position shift value of the lens sheet 65 along x-direction (i.e. distance from the valley, as indicayed by the line L_{V}, to the symmetrical line L_{S} of the alignment mark 63M).

Dimensional factors X and Y of the alignment mark 63M are known values which can be inputted into an alignment shift analysis software before capturing the alignment mark images. Y1 and Y2 could be obtained by checking brightness values of the reference mark image 66I-R′ and the indicator image 66I-I′, respectively. ΔX can be calculated by the formula (2):

$$Δ X = \frac{X}{2 Y} \cdot ( Y 2 - Y 1 ) . \qquad ( 2 )$$

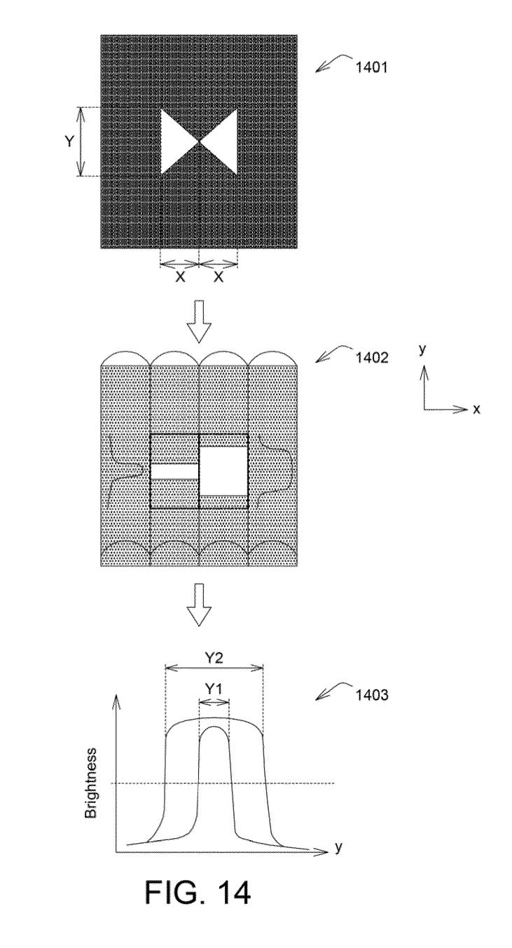

The 3D alignment method of display panel and lens sheet according to the second embodiment is similar to the steps of FIG. 9. The difference of the alignment method between the first and second embodiments is brightness comparison and calculation formula. FIG. 14 depicts the corresponding drawings for illustrating relative steps of FIG. 9 according to the second embodiment. Please refer to FIG. 9 and FIG. 14 for steps of 3D alignment method of the second embodiment. In the second embodiment, the display panel 43 with at least two alignment marks is provided, and each alignment mark comprising a reference mark and an indicator which are two triangles with mirror symmetry, as shown in the pattern 1401 of FIG. 14. The dimensional factors such as X and Y of pattern 1401 of FIG. 14 are inputted to an alignment shift analysis software 55 (step 902), wherein X is height of one of the triangles and parallel to x-direction, and Y is a bottom length of one of the triangles and parallel to y-direction. In the second embodiment, step of analyzing the alignment mark images (step 904) by the alignment shift analysis software 55 comprises averaging brightness of the alignment mark images to the lens direction (i.e. x-direction), including an indicator image averaged brightness and a reference mark image averaged brightness of each reference mark image to the lens direction, as illustrated in the pattern 1402 of FIG. 14. Also, a width value Y1 of the indicator image averaged brightness and a width value Y2 of the reference mark image averaged brightness are obtained, as illustrated in the pattern 1403 of FIG. 14. In the second embodiment, a x-position shift value along x-direction, ΔX, can be calculated (step 905) according to the formula (2) as discussed and presented above.

It is noted that the butterfly-shaped alignment mark 63M of the second embodiment includes two mirror-symmetric triangles. Although one of the triangles is given name of “indicator” and the other is given name of “reference mark” according to the aforementioned descriptions, those names can be adopted alternatively, which the element 63M-R could be treated as an indicator and the element 63M-I could be treated as an reference mark. The shape difference between the images of two marks (63M-R and 63M-I) has indicated whether the position shift between the lens sheet and the display panel occurs, no matter which one of the triangles is named as an “indicator” or a “reference mark”.

### Third Embodiment

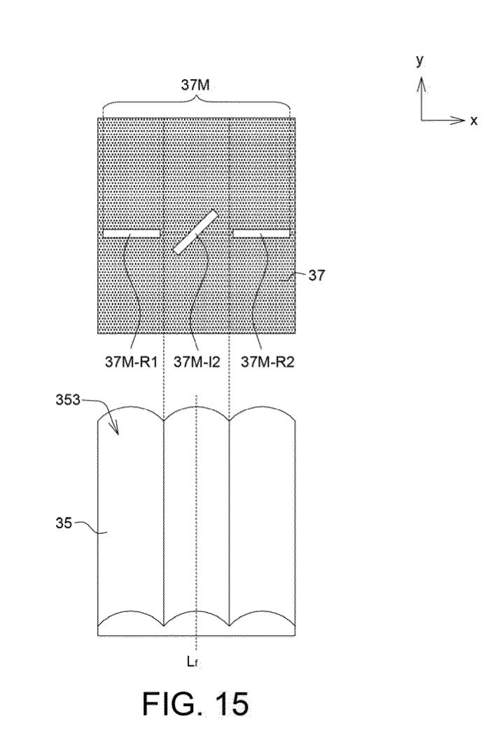

FIG. 15 schematically illustrates a lens sheet and an alignment mark on the display panel according to the third embodiment of the disclosure. Configuration and principle of position-shift indication of the alignment mark 37M of the third embodiment is similar to the alignment mark 33M of the first embodiment. The difference of configuration between the alignment marks 37M and 33M of the third and first embodiments is that each alignment mark 37M is positioned correspondingly to three hemicylindrical lens 353 of the lens sheet 35 while each alignment mark 33M is positioned correspondingly to one hemicylindrical lens 353 of the lens sheet 35.

The alignment mark 37M on the display panel 37 comprises an indicator 37M-I slanted to the lens direction(i.e. x-direction), a first group of reference line 37M-R1 and a second group of reference line 37M-R2 parallel to the lens direction. The first group of reference line 37M-R1 and the second group of reference line 37M-R2 are positioned at the left side and right side of the indicator 37M-I. Although each of the first group of reference line 37M-R1 and the second group of reference line 37M-R2 includes one line, the disclosure is not limited thereto and two or more lines could be selectively adopted as the reference lines.

After staking the lens sheet 35 on the alignment mark 37M, the alignment mark 37M on the display panel 37 is identifiable through the lens sheet 35, and present a corresponding alignment mark image on top of the lens sheet 35. The shift value of the lens sheet 35 can also be estimated and calculated according to a correlation of positions of the indicator image and the reference mark images by alignment shift analysis software.

If the lens sheet 35 is shifted to the right side of the display panel 37 during pre-alignment (which means the focusing line L_{f} of the hemicylindrical lens 353 is positioned relatively to the right side of the indicator 37M-I and a lens focusing point on the mark of the indicator 37M-I is shifted to an upward-direction), the projected indicator image consequently moves upwardly. If the lens sheet 35 is shifted to the left side of the display panel 37 during pre-alignment (which means the focusing line L_{f} of the hemicylindrical lens 353 is positioned relatively to the left side of the indicator 37M-I and a lens focusing point on the mark of the indicator 37M-I is shifted to an downward-direction), the projected indicator image consequently moves downwardly.

### Fourth Embodiment

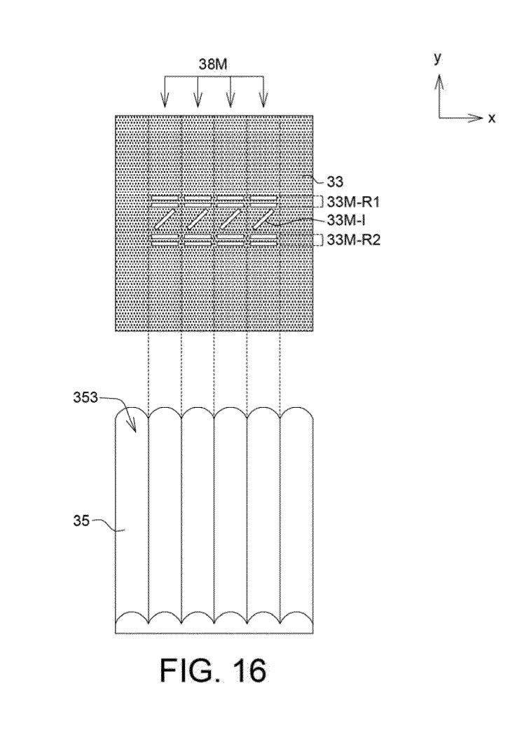

FIG. 16 schematically illustrates a lens sheet and an alignment mark on the display panel according to the fourth embodiment of the disclosure. Configuration and principle of position-shift indication of the alignment mark 33M of the third embodiment are identical to that of the first embodiment, which are not redundantly described. The difference between the fourth and first embodiments is that several alignment marks 33M are adopted in the fourth embodiment; for example, 4 of alignment marks 33M are formed correspondingly to 4 of hemicylindrical lens 353, for quick identification and more accurate alignment. Practically, the lens pitch of the lens sheet 35 is very small (e.g. about 0.188 mm for a current lens sheet). It is easier to identify the location of plural alignment marks aggregately formed on the display.

### Fifth Embodiment

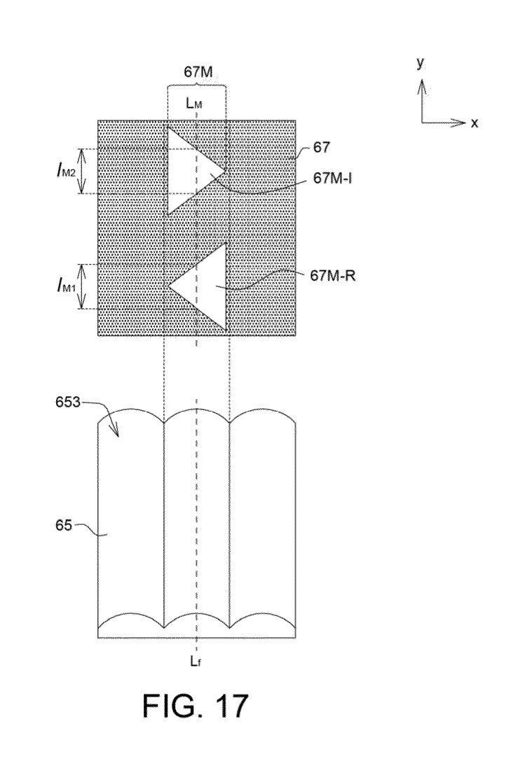

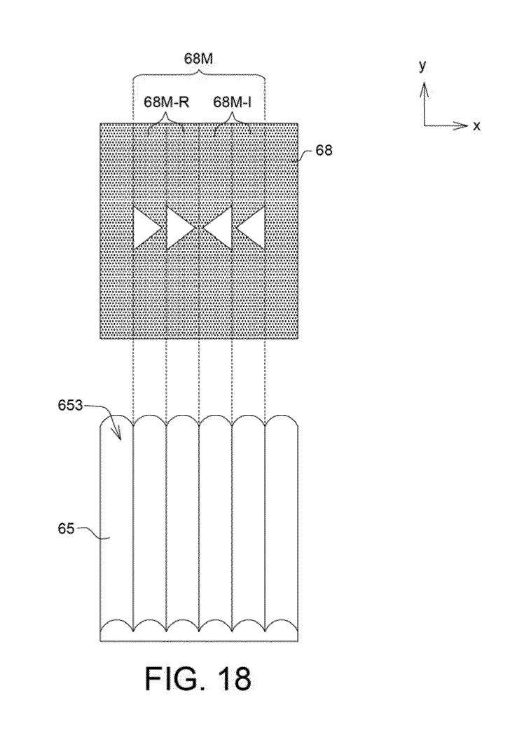

FIG. 17 schematically illustrates a lens sheet and an alignment mark on the display panel according to the fifth embodiment of the disclosure. Configuration and principle of position-shift indication of the alignment mark 67M of the fifth embodiment is similar to the alignment mark 63M of the second embodiment. The difference of configuration between the alignment marks 67M and 63M of the fifth and second embodiments is that each alignment mark 63M is positioned correspondingly to two hemicylindrical lenses 653 of the lens sheet 65 while each alignment mark 67M is positioned correspondingly to one hemicylindrical lens 353 of the lens sheet 35.

In the fifth embodiment, each alignment marks 67M on the display panel 67 comprises an indicator 67M-I and a reference mark 67M-R, which are two triangles with left-and-right inversed shapes positioned correspondingly to one hemicylindrical lens 653. The indicator 67M-I is positioned above the reference mark 67M-R, as shown in FIG. 17. Also, the triangle points of the indicator 67M-I and the reference mark 67M-R are positioned correspondingly to the valleys of the hemicylindrical lenses 653, and the heights (width) of the triangle indicator 67M-I and the reference mark 67M-R are close to or substantially the same as the lens pitch.

After staking the lens sheet 65 on the alignment mark 67M, the alignment mark 67M on the display panel 67 is identifiable through the lens sheet 65, and present a corresponding alignment mark image on top of the lens sheet 65. The shift value of the lens sheet 65 can also be estimated and calculated according to the sizes of the indicator image and the reference mark images by alignment shift analysis software.

If the lens sheet 65 and the display panel 67 are accurately aligned at a correct position, which means the focusing line L_{f} of the hemicylindrical lens 653 is aligned with the middle line L_{M} of indicator 67M-I and the reference mark 67M-R (i.e. the focusing length l_{M1} of the reference mark 67M-R identical to the focusing length l_{M2} of the indicator 67M-I), the indicator image and the reference mark image present substantially identical sizes (shapes). If the lens sheet 65 is shifted to the right side of the display panel 67 during pre-alignment (which means the focusing line L_{f} of the hemicylindrical lens 653 is positioned relatively to the right side of the indicator 67M-I and the reference mark 67M-R, and the focusing length l_{M1} of the reference mark 67M-R is larger than the focusing length l_{M2} of the indicator 67M-I), the size of the projected indicator image is smaller than the size of the projected reference mark image. Similarly, if the lens sheet 65 is shifted to the left side of the display panel 67 during pre-alignment, the size of the projected indicator image is larger than the size of the projected reference mark image.

### Sixth Embodiment

FIG. 18 schematically illustrates a lens sheet and an alignment mark on the display panel according to the sixth embodiment of the disclosure. Configuration and principle of position-shift indication of the alignment mark 68M of the fifth embodiment is are identical to that of the alignment mark 63M of the second embodiment, which are not redundantly described. The difference between the sixth and second embodiments is that the alignment mark 68M includes two reference marks 68M-R and two indicators 68M-I. Similarly, it is easier and more quick to identify the location of the alignment mark 68M on the display panel 68 if more reference marks and indicators are adopted.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A three-dimensional (3D) display, at least comprising:
a display panel, comprising a display medium sandwiched between two substrates, and at least one alignment mark formed at one of the substrates, and each alignment mark comprising an indicator and a reference mark;
a lens sheet, disposed on the display panel, and the lens sheet having an array of plural lenticular elements arranged in a lens direction, wherein the alignment marks are identifiable through the lens sheet and corresponding alignment mark images are presented on the lens sheet, and each alignment mark image comprises an indicator image and a reference mark image;
wherein whether the alignment between the lens sheet and the display panel is accurate is determined by a correlation between the indicator image and the reference mark image.

2. The 3D display according to claim 1, wherein the alignment between the lens sheet and the display panel is accurate is determined according to positions or sizes of the indicator image and the reference mark image.

3. The 3D display according to claim 1, wherein the reference mark comprises one or more reference lines parallel to the lens direction, and the indicator is a slanted line from the lens direction.

4. The 3D display according to claim 3, wherein the reference mark comprises two groups of reference lines and the indicator is positioned between the two groups of reference lines.

5. The 3D display according to claim 4, wherein the reference mark and the indicator of each alignment mark are positioned correspondingly to one of the lenticular elements.

6. The 3D display according to claim 4, wherein the reference mark and the indicator of each alignment mark are positioned correspondingly to three of the adjacent lenticular elements.

7. The 3D display according to claim 4, wherein the indicator image is substantially at a middle position between the reference mark images while the alignment between the lens sheet and the display panel is accurate.

8. The 3D display according to claim 3, wherein a focusing line of one of the lenticular elements is aligned with a center of the indicator while the alignment between the lens sheet and the display panel is accurate.

9. The 3D display according to claim 1, wherein the reference mark and the indicator are mirror patterns positioned correspondingly to one or two of the lenticular elements.

10. The 3D display according to claim 9, wherein the reference mark and the indicator are two triangles with mirror symmetry.

11. The 3D display according to claim 10, wherein the points of the triangles are positioned correspondingly to valleys of the lenticular elements.

12. The 3D display according to claim 9, wherein the indicator image and the reference mark image present substantially identical sizes (shapes) while the alignment between the lens sheet and the display panel is accurate.

13. An alignment method, applied to a lenticular-type 3D display, comprising:
providing a display panel with at least one alignment mark and a lens sheet disposed on the display panel, and each alignment mark comprising an indicator and a reference mark, and the lens sheet having an array of plural lenticular elements arranged in a lens direction ;
capturing identifiable alignment mark images presented on top of the lens sheet, and the alignment mark images generated by the corresponding alignment marks through the lens sheet, wherein each alignment mark image comprises an indicator image and a reference mark image;
analyzing the alignment mark images to determine whether an alignment between the lens sheet and the display panel is accurate according to a correlation of positions or sizes of the indicator image and the reference mark image;
calculating and obtaining a position shift result for each of the alignment marks by an alignment shift analysis software; and
adjusting a corresponding position between the display panel and the lens sheet according to the position shift results of the alignment marks.

14. The alignment method according to claim 13, further comprising step of calculating a rotation angle between the display panel and the lens sheet from position shift calculation results of the alignment marks.

15. The alignment method according to claim 13, wherein step of analyzing the alignment mark images comprising averaging brightness of the alignment mark images to the lens direction.

16. The alignment method according to claim 15, further comprising inputting dimensional factors of each alignment mark before capturing the alignment mark images, wherein step of calculating the position shift result comprises comparing positions corresponding to the captured alignment mark images with averaged brightness and original positions corresponding to the dimensional factors of each alignment mark.

17. The alignment method according to claim 13, wherein the reference mark of each alignment mark comprises one or more reference lines parallel to the lens direction, and the indicator of each alignment mark is a slanted line from the lens direction.

18. The alignment method according to claim 17, wherein the reference mark comprises two groups of reference lines, and the indicator is positioned between the two groups of reference lines.

19. The alignment method according to claim 17, wherein the reference mark and the indicator of each alignment mark are positioned correspondingly to one of the lenticular elements, or positioned correspondingly to three of the adjacent lenticular elements.

20. The alignment method according to claim 17, further comprising:
inputting dimensional factors X and Y of each alignment mark before capturing the alignment mark images, wherein X is a horizontal width of indicator of the indicator, and Y is a vertical width of the indicator, and the indicator is the slanted line with a center virtually at half the distance between the reference lines;
averaging brightness of the alignment mark images to the lens direction, including an indicator image averaged brightness and a reference mark image averaged brightness of each reference mark image to the lens direction, wherein the lens direction is x-direction;
obtaining an image shift value along y-direction, ΔY, by comparing the indicator image averaged brightness and the reference mark image averaged brightness; and
calculating a x-position shift value along x-direction, ΔX, according to formula:
$$Δ X = \frac{X}{Y} \cdot Δ Y .$$

21. The alignment method according to claim 13, wherein the reference mark and the indicator are mirror patterns positioned correspondingly to one or two of the lenticular elements.

22. The alignment method according to claim 21, wherein the indicator image and the reference mark image present substantially identical sizes (shapes) while the alignment between the lens sheet and the display panel is accurate.

23. The alignment method according to claim 13, wherein the reference mark and the indicator are two triangles with mirror symmetry.

24. The alignment method according to claim 23, further comprising:
inputting dimensional factors X and Y of each alignment mark before capturing the alignment mark images, wherein X is height of one of the triangles and parallel to x-direction, and Y is a bottom length of one of the triangles and parallel to y-direction;
averaging brightness of the alignment mark images to the lens direction, including an indicator image averaged brightness and a reference mark image averaged brightness of each reference mark image to the lens direction, wherein the lens direction is x-direction;
obtaining a width value Y1 of the indicator image averaged brightness and a width value Y2 of the reference mark image averaged brightness; and
calculating a x-position shift value along x-direction, ΔX, according to formula:
$$Δ X = \frac{X}{2 Y} \cdot ( Y 2 - Y 1 ) .$$

25. The alignment method according to claim 13, further comprising providing a 3D alignment device at least comprising:
a panel stage and a 3D component stage for respectively carrying the display panel and the lens sheet, and wherein an image capture tool is disposed above the 3D component stage to capture identifiable alignment mark images presented on top of the lens sheet;
a control unit, coupled to the panel stage, the 3D component stage, the alignment shift analysis software and the image capture tool, to adjust the corresponding position between the display panel and the lens sheet
according to the position shift results of the alignment marks.
